(19) United States
(12) Patent Application Publication
(10) Pub. No.: US 2014/0273682 A1
(43) Pub. Date: Sep. 18, 2014

(54) ROOFING MEMBRANE INCORPORATING A CENTRAL LAMINATED STRUCTURE

(71) Applicant: Building Materials Investment Corporation, Wilmington, DE (US)

(72) Inventors: Linlin Xing, Wayne, NJ (US); Thomas John Taylor, West Nyack, NY (US)

(73) Assignee: Building Materials Investment Corporation, Wilmington, DE (US)

(21) Appl. No.: 14/213,149

(22) Filed: Mar. 14, 2014

Related U.S. Application Data
(60) Provisional application No. 61/792,828, filed on Mar. 15, 2013.

(51) Int. Cl. E04D 5/10; B32B 37/04

(52) U.S. Cl. CPC E04D 5/10; B32B 37/04
USPC 442/1; 156/313

(57) ABSTRACT

Exemplary embodiments of a TPO roofing membrane are provided that use a reinforcing laminate having a scrim encapsulated by polymer films as a middle layer of the TPO roofing membrane. The reinforcing laminate can have an upper polypropylene film, a lower polypropylene film, and a scrim fabric provided between the upper polypropylene film and the lower polypropylene film. The scrim fabric can be a polyester scrim fabric or a glass scrim fabric. The upper and/or lower polypropylene films can be filled with a reflective pigment and/or a fire retardant.

### CROSS-REFERENCE TO RELATED APPLICATION(S)

This application relates to and claims priority from U.S. patent application Ser. No. 61/792,828 filed Mar. 15, 2013, the entire disclosure of which is hereby incorporated by reference.

### FIELD OF THE DISCLOSURE

The present disclosure relates to exemplary embodiments of a thermoplastic polyolefin roofing membrane, and more particularly, to exemplary embodiments of a thermoplastic polyolefin roofing membrane using a central laminated structure for reinforcement.

### BACKGROUND INFORMATION

Conventional thermoplastic polyolefin (“TPO”) based roofing membranes can be made up of three layers. As shown in FIG. 1, a typical TPO based roofing membrane 100 can have an upper layer 110 that can be a TPO sheet, which can be formulated with ultraviolet absorbers and stabilizers, thermal stabilizers, pigments and stabilizers. Typically, the upper layer can be formulated to provide for long term stability in an outdoor environment. The bottom layer 130 of the TPO roofing membrane 100 can also be a TPO sheet, and generally contains fewer or lower concentrations of stabilizers.

The central layer 120 of the conventional TPO roofing membrane 100 is typically a fabric which acts as a reinforcement to improve the physical performance of the roofing membrane. The fabric 120 can contribute significantly to the tensile strength of the roofing membrane and provide for dimensional stability. Typically, the fabric reinforcement 120 comprises a polyester based scrim. Glass based scrims can also be used where additional weight or improved dimensional stability may be required.

The three layers are typically laminated together at elevated temperatures such that the upper layer 110 and bottom layer 130 are fused or welded together through the interstices of the scrim of the middle layer 120. The scrim 120 is generally a very significant portion of the cost of a roofing membrane.

### BRIEF DESCRIPTION OF THE DRAWINGS

The foregoing and other exemplary objects of the present disclosure will be apparent upon consideration of the following detailed description, taken in conjunction with the accompanying exemplary drawings and claims, in which like reference characters refer to like parts throughout, and in which:

FIG. 1 is an illustration of a conventional thermoplastic polyolefin based roofing membrane; and

FIG. 2 is an illustration of an exemplary embodiment of a reinforcing laminate according to the present disclosure.

Throughout the figures, the same reference numerals and characters, unless otherwise stated, are used to denote like features, elements, components or portions of the illustrated embodiments. Moreover, while the subject technology will now be described in detail with reference to the figures, it is done so in connection with the illustrative embodiments. It is intended that changes and modifications can be made to the described embodiments without departing from the true scope and spirit of the subject disclosure.

### SUMMARY OF EXEMPLARY EMBODIMENTS OF THE DISCLOSURE

At least some of the above described problems can be addressed by exemplary embodiments of the colored thermoplastic polyolefin roofing membrane having an enhanced solar reflectance according to the present disclosure.

In some exemplary embodiments of the present disclosure, a reinforcing laminate for a middle layer of a polyolefin roofing membrane can be provided, comprising an upper polypropylene film, a lower polypropylene film, and a scrim fabric provided between the upper polypropylene film and the lower polypropylene film. The scrim fabric can be a polyester scrim fabric or a glass scrim fabric.

The upper polypropylene film or the lower polypropylene film can be a single layer film, or a multilayer film. The upper polypropylene film or the lower polypropylene film can be a high strength film with axial or biaxial orientation. The upper polypropylene film or the lower polypropylene film can be filled with a reflective pigment, which can be titanium dioxide.

The upper polypropylene film or the lower polypropylene film can contain fire retardant. The fire retardant can comprise halogenated flame retardants, non-halogenated flame retardants or a mixture of halogenated flame retardants and non-halogenated flame retardants. The halogenated flame retardants can comprise a halogenated organic species or hydrocarbons. The non-halogenated flame retardants can comprise one or more of magnesium hydroxide, aluminum trihydrate, zinc borate, ammonium polyphosphate, melamine polyphosphate, clays and antimony oxide.

In some exemplary embodiments of the present disclosure, a thermoplastic polyolefin roofing membrane can be provided, comprising a top layer, a bottom layer, and a reinforcing laminate provided between the top layer and bottom layer, the reinforcing laminate comprising an upper polypropylene film, a lower polypropylene film, and a scrim fabric provided between the upper polypropylene film and the lower polypropylene film. The scrim fabric can be a polyester scrim fabric, or a glass scrim fabric.

The upper polypropylene film or the lower polypropylene film can be a single layer film, or a multilayer film. The upper polypropylene film or the lower polypropylene film can be a high strength film with axial or biaxial orientation. The upper polypropylene film or the lower polypropylene film can be filled with a reflective pigment, which can be titanium dioxide.

In some exemplary embodiments of the present disclosure, a method of manufacturing a thermoplastic polyolefin roofing membrane can be provided, comprising providing an upper layer of a thermoplastic polyolefin roofing membrane, providing a bottom layer of a thermoplastic polyolefin roofing membrane, providing a reinforcing laminate between the upper layer and the bottom layer of the thermoplastic polyolefin roofing membrane, wherein providing the reinforcing laminate comprises providing an upper polypropylene film, providing a lower polypropylene film, and providing a scrim fabric between the upper polypropylene film and the lower polypropylene film, and fusing the upper layer to the bottom layer through one or more interstices of the scrim fabric of the reinforcing laminate.

These and other objects, features and advantages of the present disclosure will become apparent upon reading the following detailed description of embodiments of the present disclosure, when taken in conjunction with the appended claims.

### DETAILED DESCRIPTION OF EXEMPLARY EMBODIMENTS OF DISCLOSURE

In certain exemplary embodiments according to the present disclosure, a reinforcing laminate is provided for a middle layer of a TPO roofing membrane. The reinforcing laminate can be made up of three or more layers.

FIG. 2 is an illustration of an exemplary embodiment of a reinforcing laminate 200 according to the present disclosure. The reinforcing laminate 200 can be a polyester scrim fabric or a glass scrim fabric that can be provided between an upper polypropylene film 210 and a lower polypropylene film 230. The polypropylene films can be a single layer or can be multilayers, with tie layers or other like layers. The polypropylene films can be high strength films, with axial or biaxial orientation. Where high strength polymer films are used, the polyester scrim can be down gauged. Other polymer films can be used instead of the polypropylene films that can laminate to TPO.

The upper laminating polypropylene film 210 and the lower laminating polypropylene film 230 can be filled with a reflective pigment, such as but not limited to titanium dioxide. The upper laminating polypropylene film and the lower laminating polypropylene film can contain fire retardant, such as but not limited to, halogenated flame retardants, non-halogenated flame retardants, and mixtures thereof. Examples of halogenated flame retardants can include halogenated organic species or hydrocarbons such as hexabromocyclododecane or N,N′-ethylene-bis-(tetrabromophthalimide). Exemplary non-halogenated flame retardants can include magnesium hydroxide, aluminum trihydrate, zinc borate, ammonium polyphosphate, melamine polyphosphate, clays and antimony oxide. An ultraviolet stabilizer package can also be added. The fire retardant in the upper laminating polypropylene film 210 and the lower laminating polypropylene film 230 can be in addition to a reflective pigment.

The reinforcing laminate 200 in the TPO roofing membrane of the exemplary embodiments of the present disclosure can be pre-manufactured or it could be manufactured on site.

The reinforcing laminate 200 can be provided as a middle layer of a TPO roofing membrane, the membrane having an upper layer and a bottom layer that can be TPO sheets. The upper and bottom layers of the roofing membrane can be joined by fusing them, welding, bonding, adhering or methods known to those skilled in the art, through the interstices of the scrim of the middle layer. The exemplary embodiments of the present disclosure are not limited to any such method.

Conventional TPO membrane manufacturing requires two passes to produce TPO roofing membranes having an improved reflectance where a reflective cap layer was provided beneath a top colored TPO cap layer, or an external supply would be required of one of the TPO layers. The exemplary embodiments of the present disclosure can incorporate reinforcement and reflectivity into a single layer and thus maintain conventional manufacturing processes.

Further, TPO roofing membranes are generally produced to three different thicknesses, such as 45, 60 and 80 millimeters. Thicker membranes can be more robust and have increased longevity for roofing applications. The exemplary embodiments of the present disclosure enable the thicker roofing membranes to be produced without the need for additional high cost TPO polymer or additives.

The present disclosure provides exemplary embodiments of a thermoplastic polyolefin roofing membrane using a scrim encapsulated by polymer films as a middle layer of a TPO membrane that can provide for cost savings, productivity improvements, enhanced strength and greater reflectivity of the TPO membrane. The middle layer can provide a reinforcing laminate that can be a polyester film or a glass scrim fabric sandwiched between an upper polypropylene film and a lower polypropylene film.

The foregoing merely illustrates the principles of the disclosure. Various modifications and alterations to the described embodiments will be apparent to those skilled in the art in view of the teachings herein. It will thus be appreciated that those skilled in the art will be able to devise numerous layers, configurations, arrangements, manufacture and methods which, although not explicitly shown or described herein, embody the principles of the disclosure and are thus within the spirit and scope of the disclosure.

What is claimed is:

1. A reinforcing laminate for a middle layer of a polyolefin roofing membrane comprising:
an upper polypropylene film;
a lower polypropylene film; and
a scrim fabric provided between the upper polypropylene film and the lower polypropylene film.

2. The reinforcing laminate according to claim 1, wherein the scrim fabric is a polyester scrim fabric.

3. The reinforcing laminate according to claim 1, wherein the scrim fabric is a glass scrim fabric.

4. The reinforcing laminate according to claim 1, wherein the upper polypropylene film or the lower polypropylene film is a single layer film.

5. The reinforcing laminate according to claim 1, wherein the upper polypropylene film or the lower polypropylene film is a multilayer film.

6. The reinforcing laminate according to claim 1, wherein the upper polypropylene film or the lower polypropylene film is a high strength film with axial or biaxial orientation.

7. The reinforcing laminate according to claim 1, wherein the upper polypropylene film or the lower polypropylene film is filled with a reflective pigment.

8. The reinforcing laminate according to claim 7, wherein the reflective pigment is titanium dioxide.

9. The reinforcing laminate according to claim 1, wherein the upper polypropylene film or the lower polypropylene film contains fire retardant.

10. The reinforcing laminate according to claim 9, wherein the fire retardant comprises halogenated flame retardants, non-halogenated flame retardants or a mixture of halogenated flame retardants and non-halogenated flame retardants.

11. The reinforcing laminate according to claim 10, wherein the halogenated flame retardants comprise a halogenated organic species or hydrocarbons.

12. The reinforcing laminate according to claim 10, wherein the non-halogenated flame retardants comprise one or more of magnesium hydroxide, aluminum trihydrate, zinc borate, ammonium polyphosphate, melamine polyphosphate, clays and antimony oxide.

13. A thermoplastic polyolefin roofing membrane comprising:
a top layer;
a bottom layer; and
a reinforcing laminate provided between the top layer and bottom layer, the reinforcing laminate comprising:
an upper polypropylene film;
a lower polypropylene film; and
a scrim fabric provided between the upper polypropylene film and the lower polypropylene film.

14. The thermoplastic polyolefin roofing membrane according to claim 13, wherein the scrim fabric is a polyester scrim fabric.

15. The thermoplastic polyolefin roofing membrane according to claim 13, wherein the scrim fabric is a glass scrim fabric.

16. The thermoplastic polyolefin roofing membrane according to claim 13, wherein the upper polypropylene film or the lower polypropylene film is a single layer film.

17. The thermoplastic polyolefin roofing membrane according to claim 13, wherein the upper polypropylene film or the lower polypropylene film is a multilayer film.

18. The thermoplastic polyolefin roofing membrane according to claim 13, wherein the upper polypropylene film or the lower polypropylene film is a high strength film with axial or biaxial orientation.

19. The thermoplastic polyolefin roofing membrane according to claim 13, wherein the upper polypropylene film or the lower polypropylene film is filled with a reflective pigment.

20. A method of manufacturing a thermoplastic polyolefin roofing membrane, comprising:
providing an upper layer of a thermoplastic polyolefin roofing membrane;
providing a bottom layer of a thermoplastic polyolefin roofing membrane;
providing a reinforcing laminate between the upper layer and the bottom layer of the thermoplastic polyolefin roofing membrane, wherein providing the reinforcing laminate comprises:
providing an upper polypropylene film;
providing a lower polypropylene film; and
providing a scrim fabric between the upper polypropylene film and the lower polypropylene film; and
fusing the upper layer to the bottom layer through one or more interstices of the scrim fabric of the reinforcing laminate.
